(19) United States
(12) Patent Application Publication
(10) Pub. No.: US 2026/0275774 A1
(43) Pub. Date: Sep. 17, 2026

(54) Leaf Element for a Vehicle, in Particular for a Motor Vehicle, and Vehicle

(71) Applicant: Bayerische Motoren Werke Aktiengesellschaft, Muenchen (DE)

(72) Inventors: Erik BRADEN, Muenchen (DE); Markus KOEDDERITZSCH, Woerthsee (DE)

(21) Appl. No.: 19/168,353

(22) PCT Filed: Jun. 4, 2024
(86) PCT No.: PCT/DE2024/100499

§ 371 Date: Sep. 24, 2025

(30) Foreign Application Priority Data
Jun. 22, 2023 (DE) 10 2023 116 357.4

(51) Int. Cl. E05B 77/12; E05B 81/76; E05B 81/90

(52) U.S. Cl. CPC E05B 77/12; E05B 81/76; E05B 81/90

(57) ABSTRACT

A leaf element for a vehicle has an outer handle which can be gripped by a person using their hand and which can be moved relative to a base body of the leaf element from a rest position into at least one actuated position, wherein by moving the outer handle from the rest position into the actuated position, a lock can be mechanically unlocked, by which lock, the leaf element that can be movably arranged on the structure of the vehicle between a closed position and at least one open position, is to be secured in the closed position. A securing device is provided which has an electrically operatable actuator that can be electrically operated as a result of a detection of an application of force to the vehicle due to an accident. The securing device can be switched from a blocking state, which secures the outer handle in the rest position, into a release state, which releases a movement of the outer handle from the rest position into the actuated position, via the actuator.

### BACKGROUND AND SUMMARY

The invention relates to a leaf element for a vehicle, in particular for a motor vehicle. The invention furthermore relates to a vehicle, in particular a motor vehicle, having at least one such leaf element.

WO 2007/118552 A1 discloses a motor vehicle having a vehicle door which has a door lower part and an upper window part which are separated by a window sill. WO 2020/01137 A1 discloses a device for actuating a vehicle door of a vehicle as known, having a sensor device which is configured to record a force acting on the vehicle door and to generate corresponding sensor data. Furthermore, DE 102017202 114 A1 discloses a motor vehicle having at least one side door which has a door body. Furthermore, WO 2006/007916 A1 discloses a motor vehicle door having an inner module and an outer module.

It is an object of the present invention to provide a vehicle door for a motor vehicle, in particular a passenger car, and a motor vehicle, in particular a passenger car, so that particularly advantageous operation can be realized.

This object is achieved according to the invention by a leaf element and by a vehicle having such a leaf element in accordance with the independent claims. Advantageous embodiments of the invention are the subject of the dependent claims.

A first aspect of the invention relates to a leaf element for a vehicle, in particular for a motor vehicle. This means that the vehicle, which is preferably designed as a motor vehicle, in particular as a motor vehicle and very particularly as a passenger vehicle, has the leaf element in its completely produced state. The leaf element is understood to mean a structural element which is to be hold or is held, that is to say is arrangeable or arranged. movably, in particular pivotably, on a body of the vehicle, which body is designed, for example, as a self-supporting body and the interior of which vehicle, also referred to as a passenger cell or passenger compartment, is formed by the body. The leaf element is thus formed separately from the body in the completely produced state of the vehicle and is held on the body in a movable, in particular pivotable, manner. The body is preferably designed as a self-supporting body.

In particular, the leaf element is assigned a body opening of the body. The leaf element can be moved, in particular pivoted, relative to the body between a closed position and at least one open position. In the closed position, at least a partial region of the body opening is closed by the leaf element. In the open position, the leaf element releases the partial region of the body opening. In particular, the leaf element can be, for example, a door, in particular a side door, so that the body opening is formed, for example, as a door opening. Thus, for example, in the open position of the leaf element, a person can enter the interior or exit the interior via the exposed partial region of the assembly opening.

Furthermore, it is contemplated for the leaf element to be a flap such as a tailgate or a front flap. For example, the leaf element can be a trunk flap or a trunk lid or a bonnet. Thus, for example, the body opening can be an in particular lateral or rear door opening or a front or rear storage space opening, so that, for example, a front or rear storage space, in particular a trunk, of the vehicle can be accessible via the partial region of the body opening that is exposed in the open position of the leaf element. Thus, the leaf element is an attachment part which is formed separately from the body and which can be arranged or is arranged on the body in a movable, in particular pivotable manner.

The leaf element has an outer handle. The outer handle is a handle element on the exterior side which, in particular when the leaf element is designed as the door, is a handle element on the exterior side of the door. In the installation position of the leaf element, the outer handle (handle element) is arranged on an exterior side of the leaf element and thus in a vicinity of the vehicle, wherein the leaf element assumes its installation position in the fully produced state of the vehicle having the leaf element and in the closed position of the leaf element. Thus, in the installation position of the leaf element, the outer handle is facing away from the interior, thus arranged on the exterior side of the leaf element facing away from the interior. A person who is present in the surroundings of the vehicle and thus of the leaf element can grasp the outer handle (handle element) using their hand and in the process, for example, at least partially grasp around it and, for example, subsequently exert a force on the outer handle, also referred to as handle element, and thus on the leaf element via the outer handle, in order to thereby, for example, manipulate the leaf element, that is, in particular, move it, in particular pivot it, relative to the body. For example, the person can exert such a force on the leaf element via the body that the leaf element is opened by the force, and is therefore moved from the closed position into the open position relative to the body. Furthermore, for example, the person present in the surroundings can exert such a force on the outer handle and thus, via the outer handle, on the leaf element that the leaf element is closed by the force, and is therefore moved from the open position into the closed position relative to the body. In other words, the feature that the handle element is an outer handle, thus an outer handle element and is thus arranged on the outside, is to be understood to mean that the handle element is arranged on the exterior side of the leaf element, the exterior side of which, in the installation position of the leaf element and thus in the closed position of the leaf element, faces away from the interior and faces the surroundings of the vehicle and of the leaf element overall.

The outer handle is movable relative to a base body of the leaf element from a rest position into at least or exactly one actuated position. In particular, it is contemplated that the outer handle is held on the base body such that it can be moved relative to the base body of the leaf element from the rest position into the actuated position, so that the outer handle can be moved relative to the base body from the rest position into the actuated position, while the outer handle is connected to the base body and remains so. For example, the outer handle can be moved translationally and/or rotationally relative to the base body from the rest position into the actuated position. In particular when the leaf element is a door, the base body is also referred to as a door body. By moving the outer handle (handle element) from the rest position into the actuated position, a lock can be mechanically unlocked, in particular purely, and thus preferably without using or employing electrical energy. In other words, by moving the outer handle from the rest position into the actuated position relative to the base body, the lock can be unlocked mechanically, in particular purely mechanically and thus without using or employing electrical energy. In particular, if the leaf element is designed as a door, the lock is a door lock.

By means of the lock, the leaf element which can be arranged or is arranged on the body of the vehicle and can be moved, in particular pivoted, between the closed position and the at least one open position is to be secured in the closed position, in particular relative to the body. In order thus, for example, to open the leaf element which is initially located in the closed position and is thus closed and is secured in particular relative to the body by means of the lock in the closed position, the person who is present in the surroundings can, for example, move, in particular pivot, the outer handle relative to the base body from the rest position into the actuated position, as a result of which the lock is unlocked mechanically, in particular purely mechanically. As a result, for example, the person present in the surroundings can open the leaf element, in particular in that the person exerts a force on the outer handle, in particular on the outer handle located in the actuated position.

By means of the lock, the leaf element which can be or is arranged on the body of the vehicle and can be moved, in particular pivoted, between the closed position and the at least one open position is to be secured or is secured in the closed position, in particular relative to the body, so that an undesired movement of the leaf element from the closed position into the open position is prevented. By unlocking the lock, the lock releases the leaf element for a movement from the closed position into the open position. In particular, the lock can be a component of the leaf element, so that the lock can be moved, in particular pivoted, together with the leaf element relative to the structure between the closed position and the open position, for example. The lock may be adjusted between a locked state and an unlocked state, for example. By unlocking the lock, it is brought, i.e., it is transferred, from the locked state into the unlocked state. If the leaf element is for example in the closed position, during which the lock is in the locked state, the leaf element is secured by means of the lock in the closed position and thus against an undesired movement into the open position, which takes place relative to the body. The leaf element is in particular an attachment part which is formed separately from the body and which is movable between the open position and the closed position and is to be held or is held by the body.

For example, a locking element such as, for example, a master pin also referred to as a lock bolt or a striker also referred to as a lock shackle is fastened to the body, in particular to a vehicle pillar of the body which is designed, for example, as a door pillar and also referred to as a bodywork pillar or body pillar. In the closed position of the leaf element and in the locked state of the lock, for example, the lock, in particular a fork bolt of the lock, interacts, in particular in a form-fitting manner, with the locking element, whereby the leaf element is to be secured or is secured, in the closed position, in particular in a form-fitting manner. For example, the lock has a lock element, which can be, for example, the aforementioned fork bolt. In the closed position of the leaf element and in the locked state of the lock, for example, the lock element interacts with the locking element, in particular in a form-fitting manner, whereby the leaf element is to be secured or is secured in the closed position, in particular in a form-fitting manner. For example, the lock element can be moved relative to a base element of the lock and in particular relative to the locking element between the locking position and an unlocking position, in particular in a translatory and/or rotatory manner. In the closed position of the leaf element and in the locked position of the lock element, the lock element interacts, in particular in a form-fitting manner, with the locking element, whereby the leaf element is to be secured or is secured in the closed position. By or during the unlocking of the lock, for example, the lock element is moved from the locking position into the unlocking position, in which the lock element does not interact with the locking element. As a result, the leaf element is released for a movement from the closed position into the open position relative to the body. In order to be able to realize a particularly advantageous operation, i.e., actuation of the leaf element, in particular via the handle element (outer handle), it is provided according to the invention that the leaf element has a securing device, which is provided in particular in addition to the outer handle and has an electrically operable actuator. The feature that the actuator is electrically operable is to be understood to mean that the actuator can be supplied with electrical energy, that is to say with electrical current, and can therefore be electrically operated, such that the actuator can be operated and can thus be electrically operated using the electrical energy with which the actuator can be supplied or is supplied.

The actuator can be electrically operated as a result of a detection of an accident-related application of force to the vehicle. For this purpose, for example, a detection device is provided, by means of which the aforementioned accident-related application of force to the vehicle can be detected, for example, in that an accident-related force, which thus results from an accident of the vehicle, acting on the vehicle can be detected by means of the detection device. The accident-related application of force thus results from an accident of the vehicle, also referred to as a crash. The detection device can provide at least one, in particular electrical, control signal, for example as a result of the detection device detecting the accident-related application of force. By means of the control signal, for example, the actuator can be controlled or control of the actuator can be brought about, for example, by the actuator being able to receive the control signal, or, as a function of the control signal, for example, a further, in particular electrical, signal can be provided, for example, by means of an electronic computing device of the vehicle, wherein the actuator can receive the further signal, for example, as a result of which the actuator can be controlled or is controlled.

By controlling the actuator, the actuator can be electrically operated, so that the actuator can be electrically operated as a result of the detection of the accident-related application of force to the vehicle. By electrically operating the actuator, the securing device can be switched by means of the actuator from a blocking state securing the outer handle in the rest position and thus preventing, i.e., avoiding, a movement of the outer handle from the rest position into the actuated position relative to the base body into a release state releasing a movement of the outer handle from the rest position into the actuated position. In other words, for example, the securing device is initially in the blocking state, in which the outer handle is held, i.e., secured, relative to the base body in the rest position by the securing device, whereby a movement of the outer handle from the rest position into the actuated position, which movement takes place relative to the base body, is prevented, i.e., suppressed. If, for example, an accident-related application of force to the vehicle is then detected by means of the detection device, then as a result of this detection of the accident-related application of force the actuator is actuated, in particular electrically, and subsequently operated electrically, so that the securing device is switched from the blocking state to the release state by means of the actuator.

Since the securing device is switched by means of the actuator from the blocking state, also referred to as the securing state, into the release state by the actuator being actuated and thereby operated, the securing device is actively switched by means of the actuator from the blocking state into the release state as a result of the detection of the accident-related force application. In the release state, the securing device releases a movement of the outer handle relative to the base body from the rest position into the actuated position. In other words, in the release state, the securing device can be used to move the outer handle relative to the base body from the rest position into the actuated position. In the blocking state, for example, the aforementioned person who is present in the surroundings cannot move the outer handle relative to the base body from the rest position into the actuated position, since this is avoided by the securing device. However, if the securing device is in the release state, the person standing in the surroundings can move the outer handle from the rest position into the actuated position relative to the base body manually, in particular purely manually, as a result of which the lock can be unlocked mechanically, in particular purely mechanically. As a result, the person can open the leaf element.

The invention makes it possible, on the one hand, to avoid an undesired movement of the outer handle from the rest position into the actuated position in a normal state of the vehicle, that is to say when the vehicle has not had an accident, with the result that, in the normal state, the person who is present in the surroundings can easily and comfortably handle, that is to say actuate, the leaf element via the outer handle. However, if, for example, such an accident occurs in the vehicle that a power supply of the vehicle is damaged or has failed, in particular via an on-board power supply system of the vehicle, then after the accident the person who is present in the surroundings can move the outer handle manually from the rest position into the actuated position relative to the base body and thus unlock the lock mechanically, in particular purely mechanically. As a result, the leaf element can be easily and comfortably opened even after the accident, so that, for example, the aforementioned interior is easily accessible after the accident. It can be seen that the handle element (outer handle) functions, can be designed or used as an emergency unlocking operating element, wherein the emergency unlocking operating element is also referred to as an emergency unlocking or emergency unlocking element. This means that the lock can be unlocked by means of the outer handle in particular even when, for example, as a result of the aforementioned accident, it is not (any longer) possible to supply the lock with electrical energy. As a result, for example, the person present in the surroundings and acting as a first responder can get to persons present in the interior after the accident and rescue and/or care for them from the interior, for example.

For example, the actuator is assigned its own energy source, which is provided in addition to the on-board power supply system of the vehicle and is in particular electrically separated from the on-board power supply system and by means of which electrical energy can be provided for electrically operating the actuator in particular independently of the on-board power supply system and therefore also in the event of damage or in the event of failure of the on-board power supply system. In particular, the energy source, also referred to as a current source, can be a component of the securing device. For example, electrical energy can be stored or stored in the energy source, which can be provided by the energy source in order to supply the actuator with the energy stored in the energy source and thereby to operate the actuator electrically, in particular after and/or during the accident-induced application of force or the accident. This can ensure, for example, that the actuator can switch the securing device from the blocking state to the release state, while, for example, the on-board power supply of the vehicle and thus, for example, a power supply of the lock is damaged, broken or interrupted.

In order to be able to ensure a particularly advantageous and reliable actuation of the leaf element, it is provided in an embodiment of the invention that during the switching of the securing device from the blocking state to the release state resulting from the electrical operation of the actuator, a movement of the outer handle from the rest position into the actuated position is omitted and thus the outer handle remains in the rest position. This means that although the securing device allows the outer handle to be moved relative to the base body from the rest position into the actuated position by switching the securing device from the blocking state into the release state, the switching of the securing device from the blocking state into the release state, which can be brought about or is brought about by means of the actuator, is not accompanied by a movement of the outer handle from the rest position into the actuated position, so that, during and after switching the securing device from the blocking state into the release state, the outer handle remains in the rest position and the outer handle is movable or has to be moved manually relative to the base body from the rest position into the actuated position. This makes it possible to avoid an undesired, mechanical unlocking of the lock.

Preferably, the rest position and the actuated position are respective end positions of the outer handle, which is moved relative to the base body into the respective end position, but cannot be moved beyond the respective end position.

In order to be able to realize a particularly advantageous operation of the leaf element, it is provided in a further embodiment of the invention that the leaf element has an operating element by means of which the lock can be electrically unlocked by operating, in particular actuating, the operating element. The operating element can be, for example, a mechanical operating element such as, for example, a knob, a pushbutton or a pressure key. For example, the operating element can be moved relative to a corresponding base element of the leaf element between an initial position and an operating position, in particular in a translatory and/or rotatory manner. By operating, in particular actuating, the operating element, the operating element is moved, for example, from the starting position relative to the base element into the operating position, as a result of which the lock can be electrically unlocked, that is to say, as a result of which an electrical unlocking of the lock can be brought about.

In order, for example, to open the initially closed leaf element, thus to move it from the closed position into the open position, the operating element is operated, in particular actuated, for example, in particular by the person who is present in the surroundings. As a result, the lock is electrically unlocked, and therefore electrically transferred from the locked state into the unlocked state, so that the lock releases the leaf element for a movement from the closed position into the open position, which movement takes place relative to the body. The feature that the lock can be electrically unlocked by operating, in particular actuating, the operating element is to be understood in particular to mean that, for example, as a result of the operating element being operated, an electrically operable lock actuator which is designed, for example, as an electric motor is in particular electrically actuated. By controlling the lock actuator, the lock actuator is operated electrically, so that by means of the lock actuator, for example, the lock element is moved from the locking position into the unlocking position, in particular using electrical energy and thus electrically. This means that the lock element is moved electrically from the locking position into the unlocking position, whereby the lock is unlocked electrically, i.e., using the aforementioned electrical energy. A movement of the leaf element from the closed position into the open position following the electrical unlocking of the lock can then be brought about manually by the person, for example, in particular in that the person manually exerts a force, in particular a tensile force or compressive force, on the leaf element, in particular on the outer handle, and thus moves the leaf element relative to the body from the closed position into the open position.

Furthermore, it is contemplated that, as a result of the operating element being operated, the leaf element can be moved or is moved electrically, i.e., using electrical energy, from the closed position into the open position relative to the body, in particular after the lock has been unlocked, in particular electrically. For this purpose, for example, an electrically operable movement device is provided, which has, for example, in the aforementioned electrically operable lock actuator and/or at least one further electrically operable door actuator. As a result of the operating element being operated, for example, the movement device is actuated, in particular electrically, where the movement device is operated electrically, such that the leaf element is moved, in particular pivoted, from the closed position into the open position by means of the movement device using electrical energy and thus electrically relative to the body. The lock can thus be unlocked particularly comfortably, and the leaf element can be opened particularly comfortably, and can therefore be moved from the closed position into the open position. It is contemplated for the leaf element to have at least one sensor, in particular one that is electrical or electrically operated, by means of which a manipulation of the operating element brought about by a person, for example, can be detected. If, for example, a manipulation of the operating element brought about by a person, i.e., in particular a movement of the operating element brought about by a person from the starting position into the operating position, is detected by means of the sensor, the lock actuator is actuated in particular as described above, so that the lock is electrically unlocked by means of the lock actuator. As already described, the lock actuator can be part of the leaf element. Furthermore, it is contemplated that the sensor is a component of the leaf element. Furthermore, the lock can be a component of the leaf element.

In principle, it is possible, for example as a result of an accident of the vehicle, for the operating element and/or the sensor and/or the lock actuator to no longer be able to be supplied with electrical energy or electrical current, since, for example, a power supply of the operating element and/or the lock actuator and/or the sensor, in particular via the on-board power supply system, is damaged, interrupted or destroyed. Then, the lock can optionally no longer be electrically unlocked, since for example the lock actuator can no longer be operated and/or since for example by means of the sensor an operation or an actuation of the operating element can no longer be detected. In order to be able to realize a particularly high level of safety in a particularly advantageous manner, the outer handle can be moved relative to the base body from the rest position into the actuated position after the securing device has been switched from the blocking state into the release state by means of the actuator, so that the lock can be unlocked mechanically, in particular purely mechanically. However, by means of the securing device, an undesired movement of the outer handle from the rest position into the actuated position can be avoided, so that a particularly advantageous operation of the leaf element can be ensured.

In order to be able to ensure particularly advantageous operation of the leaf element, it is provided in a further embodiment of the invention that the operating element is provided on the outer handle. As a result, for example, the person present in the surroundings can operate the operating element in a particularly simple and comfortable manner and, for example, in a pull or in a movement after the operation of the operating element and thus after the electrical unlocking of the lock, can manipulate the leaf element via the outer handle and, in particular, open it.

In particular, it is contemplated for the operating element to be integrated into the outer handle (handle element). The feature that the operating element is provided on the outer handle is to be understood in particular as meaning that the operating element is held on the outer handle, in particular in such a way that the operating element is held on a base of the outer handle, wherein it is contemplated for the operating element to be formed separately from the base. The operating element can be held on the base or on the outer handle such that it is immovable or movable, in particular pivotable, so that, for example, the operating element is movable, in particular pivotable, relative to the base, in particular relative to the outer handle, between the starting position and the operating position. The lock can be electrically unlocked by means of the operating element. In order thus, for example, to open the leaf element which is initially located in the closed position and is thus closed and is secured in particular relative to the body by means of the lock in the closed position, it is operated, in particular actuated, for example the person who is present in the surroundings operates the operating element, as a result of which the lock is electrically unlocked, that is to say, as a result of which an electrical unlocking of the lock is brought about. In particular, the person touches the operating element. By operating, in particular actuating, the operating element, the lock is electrically unlocked, and therefore electrically transferred from the locked state into the unlocked state, so that the lock releases the leaf element for a movement from the closed position into the open position, which movement takes place relative to the body.

The operating element can be, for example, a mechanical operating element such as, for example, a knob, a pushbutton or a pressure key, so that the operating element can be moved, in particular translationally and/or rotationally, between the starting position and the operating position, for example relative to the outer handle and/or relative to the aforementioned base. By operating, in particular actuating, the operating element, the operating element is moved, for example, from the starting position relative to the handle element and/or relative to the base into the operating position, as a result of which the lock can be electrically unlocked, and consequently as a result of which electrical unlocking of the lock can be brought about. It is furthermore contemplated for the operating element to be designed as a touch-sensitive surface or to comprise a touch-sensitive surface, wherein the operating element is operated, that is to say is to be operated, by touching the touch-sensitive surface. In particular, the leaf element is designed such that the lock can be electrically unlocked by operating, in particular actuating, the operating element without the outer handle moving from the rest position into the actuated position, that is to say while the handle element (outer handle) does not move from the rest position into the actuated position. In particular, such a movement of the outer handle from the rest position into the actuated position is prevented by the securing device into the blocking state. In this way, a particularly advantageous, in particular a particularly comfortable and at the same time secure operation of the leaf element can be realized. In particular, the outer handle can have at least one dual function: on the one hand, the outer handle can be used, for example, by virtue of the fact that the operating element is provided on the outer handle, to be able to unlock the lock electrically and thus particularly comfortably and, for example, as a result, to be able to handle the vehicle door easily, ergonomically and thus advantageously via the outer handle. On the other hand, the outer handle can function as, be designed or used as the aforementioned emergency unlocking operating element, wherein the emergency unlocking operating element is also referred to as emergency unlocking or emergency unlocking element. This means in particular the following: For example, the operating element is or comprises the aforementioned sensor, also referred to as a detection sensor, which can be operated electrically or electronically, for example, or can be an electrical or electronic sensor. The detection sensor can be arranged in particular in the outer handle or in the base. By means of the detection sensor, for example, an operation of the operating element brought about by the person present in the surroundings can be detected. It is thus contemplated for the detection sensor to be a component of the operating element. If, for example, the detection sensor detects operation of the operating element brought about by the person, that is to say in particular a movement of the operating element brought about by the person from the starting position into the operating position, the lock actuator is actuated, in particular as described above, such that the lock is electrically unlocked by means of the lock actuator. The lock actuator can be part of the leaf element, for example.

It is furthermore contemplated for the detection sensor to be a component of the leaf element, in particular in such a way that the detection sensor is integrated into the outer handle. In particular, the detection sensor can be the operating element or be a component of the operating element. As described above, it is possible in principle, for example as a result of an accident of the vehicle, for the operating element and/or the vehicle sensor and/or the lock actuator to no longer be able to be supplied with electrical energy or electrical current, since, for example, a power supply of the operating element and/or the lock actuator and/or the detection sensor is damaged, interrupted or destroyed. Then, the lock can optionally no longer be electrically unlocked, since for example the lock actuator can no longer be operated and/or since for example by means of the detection sensor an operation or actuation of the operating element can no longer be detected, and/or since its operation can no longer be detected by the operating element itself. However, since it is now provided that the outer handle itself and thus in particular together with the operating element can be moved relative to the base body from the rest position into the actuated position, whereby the lock can be mechanically, in particular purely mechanically, unlocked, the outer handle is (also) or functions as an emergency unlocking operating element. On the one hand, it is hereby possible that the lock can be mechanically unlocked, i.e., in particular emergency-unlocked, in particular when the power supply has failed. For this purpose, for example, the person present in the surroundings moves the outer handle and thus, for example, the operating element with the outer handle from the rest position into the actuated position after the actuator has switched the securing device from the blocking state into the release state. This allows a particularly high level of safety to be realized, so that particularly advantageous and safe operation can be provided. On the other hand, the use of an additional, separate emergency unlocking operating element can be avoided, so that a particularly advantageous and reliable operation of the vehicle door can be realized in a construction-intensive, weight-effective and cost-effective manner. In addition, a particularly advantageous optical impression of the leaf element and of the vehicle can be realized overall, since, for example, an impairment of the optical impression of the vehicle by an additional, separate emergency unlocking operating element can be avoided.

In order to be able to realize a particularly advantageous operation of the leaf element, it is provided in a further embodiment of the invention that the leaf element is designed as a door, in particular as a side door, with a beltline, which is also referred to simply as a sill or window sill. In particular, the sill is or forms an edge, in particular a lower edge, by which, for example, a window opening, also referred to as a window region or window pane region, for a window, in particular a side window, of the leaf element is or is at least partially delimited, in particular downward in the vehicle vertical direction of the vehicle in the installation position of the leaf element. The leaf element assumes its installation position in the completely manufactured state of the vehicle having the leaf element. In order to be able to operate the leaf element particularly comfortably and easily, it is provided that the outer handle is arranged above the beltline, in particular in the installed position of the leaf element, in the vehicle vertical direction of the vehicle. The beltline is also simply referred to as a sill or window sill or edge or waist line, or the beltline is formed by a waist line or coincides with the waist line.

In order to be able to ensure particularly advantageous and comfortable operation of the leaf element, it is provided in a further embodiment of the invention that the operating element is arranged above the beltline in the vehicle vertical direction of the vehicle in the installed position of the leaf element.

In order to reliably avoid undesired movements of the outer handle from the rest position into the actuated position and thus to be able to ensure a particularly advantageous operation of the leaf element, it is provided in a further embodiment of the invention that in the blocking state the securing device secures the outer handle form-fittingly in the rest position.

It has thus been shown to be particularly advantageous if the securing device, i.e., at least a part of the securing device, is designed to be self-locking, so that in the blocking state the outer handle is secured by self-locking of the securing device in the rest position. By electrically operating the actuator, the self-locking of the securing device can be canceled, released or overcome in order thereby to switch the securing device from the blocking state into the release state and thus to allow the movement of the outer handle from the rest position into the actuated position.

In order to keep the outer handle particularly securely in the rest position and thus to secure it against an undesired movement from the rest position into the actuated position, it is provided in a further embodiment of the invention that the securing device has a lever arrangement which, in the blocking state, assumes a position above dead center, by which the outer handle is held in the rest position, wherein, by electrically operating the actuator, the lever arrangement can be moved out of the dead center position and can be moved beyond a dead center of the lever arrangement, as a result of which the securing device can be switched over from the blocking state into the release state and the movement of the outer handle can be released from the rest position into the actuated position. The lever arrangement is or forms, for example, a toggle lever mechanism which, by electrically operating the actuator, can be moved beyond the dead point and thus can be moved out of the dead point position, in order thereby to enable the movement of the outer handle from the rest position into the actuated position.

In order to be able to realize a particularly advantageous operation of the leaf element, for example, it is provided in one embodiment that the outer handle has an outer skin that is optically and haptically perceptible overall by the person who is present in the vicinity of the vehicle door, in particular of the vehicle. The outer skin of the outer handle (handle element) is also referred to as a handle element outer skin. In other words, the person present in the surroundings can see the outer skin with their eyes and thus optically perceive it, and the person present in the surroundings can touch the outer skin directly using their hand, in particular with their fingers, for example, and thus perceive it haptically, in particular in the completely manufactured state of the leaf element and in particular of the vehicle as a whole. The outer skin is thus a surface of the handle element that is optically and haptically perceptible by the person present in the surroundings or is formed by such a surface.

It is in particular contemplated that the aforementioned touch-sensitive surface is a part of the outer skin of the handle element, also referred to as a detection part. In particular, it is contemplated that the leaf element overall has an outer skin that is optically and haptically perceptible by the person who is present in the surroundings and is also referred to as the overall outer skin, wherein the preceding and following embodiments relating to the outer skin of the handle element can easily also be transferred to the overall outer skin and vice versa. In this case, in particular the outer skin of the handle element is a first part of the overall outer skin. For example, the leaf element has a body shell which is also referred to as a door body shell, in particular when the leaf element is designed as a door.

In particular, it is contemplated that, in particular in the completely manufactured state of the vehicle, the leaf element is to be held or is held on the body of the vehicle movably, in particular pivotably, via the body shell. In other words, for example, the leaf element is movable, in particular pivotable, over the body shell to be held or held on the structure. For this purpose, it is provided, for example, that the leaf element has at least one first hinge part which is fastened, in particular fixed, to the body shell, for example, at least indirectly, in particular directly. The first hinge part is, for example, a component of a hinge, which is also referred to as a door hinge, in particular when the leaf element is designed as a door. The hinge also has a second hinge part, which is formed in particular separately from the first hinge part. The second hinge part is fastened or can be fastened at least indirectly, in particular directly, to the body of the vehicle, in particular to the aforementioned vehicle pillar. The hinge parts are movable, in particular pivotable, connected or connectable to one another, so that the body shell is arrangeable or arranged, i.e., is to be held or is held, on the body as a whole movably, in particular pivotably, via the hinge and via the body shell. For example, the body shell is at least partially formed from a metal material. It is in particular contemplated for the body shell to be a component of the base body.

It is furthermore contemplated for the leaf element, in particular the base body, to have at least one outer paneling element, also referred to simply as a paneling element. For example, the outer paneling element is formed separately from the body shell and is fastened, in particular directly, to the body shell. The outer paneling element is also referred to as cladding. In particular when the leaf element is a door, the outer paneling element is also referred to as a door cladding or door outer cladding. At least one region of the body shell is covered and thus clad by the outer paneling element, in particular with respect to the closed position of the leaf element and in the installed position of the leaf element, toward the surroundings and thus outward, that is to say in a direction pointing away from the interior of the vehicle. For example, the outer skin paneling element has an outer skin, also referred to as paneling outer skin, wherein the previous and following embodiments regarding the outer skin paneling element and regarding the overall outer skin can also be easily transferred to the paneling outer skin and vice versa. In this case, the skin paneling is or forms, for example, a second part of the overall skin of the leaf element. In particular, it is contemplated that at least a part of the outer paneling element and thus of the paneling outer skin adjoins the window opening and/or the beltline in the installation position of the leaf element and thus in particular in the closed position of the leaf element downwards in the vehicle vertical direction of the vehicle.

In order to be able to realize a particularly advantageous operation, in particular actuation, of the leaf element, for example, it is advantageously provided that the handle element has a first partial region which forms a first part of the outer skin of the handle element and is also referred to as a first body part and which has a first direction of extent and thus extends along the first direction of extent. It is contemplated here for the first partial region to project in or along the first direction of extent from the base body, in particular from the outer paneling element. The first direction of extent is also referred to as the first direction. In the installation position of the leaf element and thus in the closed position of the leaf element, for example, the first direction runs in the vehicle transverse direction, in particular outwards and thus towards the surroundings. It is thus preferably provided that the first partial region protrudes in the first direction from the base body, in particular from the outer paneling element.

Furthermore, the handle element (outer handle) preferably has a second partial region, also referred to as a second body part, which forms a second part of the outer skin of the handle element. The second partial region of the handle element adjoins the first partial region of the handle element, in particular an end of the first partial region of the handle element facing away from the base body, wherein the second partial region of the handle element protrudes from the first partial region of the handle element in a second direction of extent running obliquely or perpendicularly to the first direction of extent (first direction), which is also referred to as second direction. As a result, for example, the second partial region is spaced apart from the base body and arranged in an at least partial overlap with the base body. In particular, the second partial region extends along the second direction of extent. In the installation position of the leaf element and with respect to the closed position of the leaf element, for example, the second direction (second direction of extent) extends upwards in the vehicle vertical direction of the vehicle or the second direction points upwards in the vehicle vertical direction of the vehicle. For example, in the installation position of the leaf element and thus with respect to the closed position of the leaf element, the second partial region of the handle element is overlapped inward in the vehicle transverse direction and thus toward the interior by the base body and thus, for example, by a part of the paneling outer skin. As a result, for example, the person present in the surroundings can grasp, in particular grasp behind, the handle element, in particular the second partial region of the handle element, in a particularly advantageous and ergonomic manner using their hand, in particular in such a way that, for example, the person can move at least one of their fingers or several of their fingers between the second partial region of the handle element surroundings data the base body. Thereupon, the person can exert a force particularly advantageously on the handle element in order thereby to be able to handle the vehicle door particularly advantageously, i.e., in particular to be able to move, in particular pivot, relative to the body.

In order to be able to realize a haptically particularly advantageous and in particular ergonomic and comfortable operation, in particular actuation, of the vehicle door, it is provided in a further embodiment of the invention that, as a result of the second partial region protruding from the first partial region in the second direction of extent, the handle element is formed in an L-shaped or V-shaped manner, in particular as a whole and thus viewed overall, and thus has an L-shape or a V-shape. In this case, the partial regions of the handle element form the L-shape or the V-shape, wherein the partial regions of the handle element are respective legs of the L-shape or of the V-shape. In this case, it is provided in particular that the handle element is connected to the base body via the first partial region of the handle element.

A second aspect of the invention relates to a vehicle preferably embodied as a motor vehicle, in particular as a motor car and very particularly as a passenger vehicle, which has at least one leaf element according to the first aspect of the invention. Advantages and advantageous configurations of the first aspect of the invention are to be regarded as advantages and advantageous configurations of the second aspect of the invention and vice versa.

Further details of the invention will become apparent from the following description of a preferred exemplary embodiment with the accompanying drawing.

### BRIEF DESCRIPTION OF DRAWING

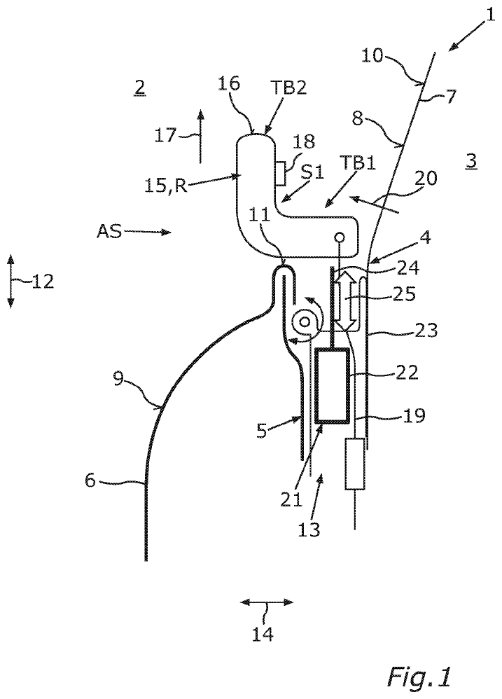

The single FIG. 1 is a schematic sectional view, in a detail, of a leaf element of a vehicle which is designed as a door.

### DETAILED DESCRIPTION OF DRAWING

FIG. 1 shows a detail of a schematic sectional view of a leaf element 1 of a vehicle which is in the present case embodied as a passenger car and is also referred to as a motor vehicle or motor car, the interior of which, which is also referred to as a passenger cell or passenger compartment, is formed by a body of the vehicle which is in particular embodied as a self-supporting body. In the exemplary embodiment shown in FIG. 1, the leaf element 1 is designed as a vehicle door, which is also referred to simply as a door. In other words, the vehicle door is a door, wherein the vehicle door is a side door in the exemplary embodiment shown in FIG. 1. The leaf element 1 is assigned a body opening of the body, wherein the body opening is formed as a lateral door opening of the body in the exemplary embodiment shown in FIG. 1. The leaf element 1 is held, and therefore arranged, on the body such that it can be moved, in particular pivoted, between a closed position and at least one open position relative to the body. In the closed position, at least a partial region of the body opening is closed by the leaf element 1. In the open position, the leaf element 1 releases at least the partial region of the body opening, so that, for example, a person initially present in the surroundings 2 of the leaf element 1 and the vehicle as a whole can enter the interior via the released partial region of the body opening. The interior is designated 3 in FIG. 1. Furthermore, for example, the person initially present in the interior 3 can exit from the interior 3 via the exposed partial region of the body opening and thus reach the surroundings 2. The leaf element 1 assumes its installation position shown in FIG. 1 in the completely manufactured state of the vehicle having the leaf element 1 and in the closed position of the leaf element 1, so that the closed position of the leaf element 1 is shown in FIG. 1.

The leaf element 1 has a base body 4, also referred to as a main body, which is also referred to as a door body in that, in the exemplary embodiment shown in FIG. 1, the leaf element 1 is designed as a vehicle door. The base body 4 has a body shell 5, which is also referred to as a door body shell in the present case. Via the body shell 5, the leaf element 1 is held on the body of the vehicle in a movable, in particular pivotable, manner. The base body 4 has at least one outer paneling element 6, which is also referred to simply as a paneling element and is formed separately from the body shell 5 and is connected, in particular directly, to the body shell 5. The outer paneling element 6 is also referred to herein as a door cladding or door outer cladding. At least a first region of the body shell 5 is covered and thus clad by the outer paneling element, in particular with respect to the closed position of the leaf element 1 towards the surroundings 2 and thus outwards, thus in a direction pointing away from the interior. It can be seen from FIG. 1 that the leaf element 1 can have a cladding element 7, which is formed, for example, separately from the outer paneling element 6. For example, the cladding element 7 is held at least indirectly, in particular directly, on the body shell 5, wherein it is contemplated for the cladding element 7 to be formed separately from the body shell 5. In particular, it is contemplated that at least a second region of the body shell 5 overlaps and is thus covered, i.e., clad, by the cladding element 7, at least with respect to the closed position of the leaf element 1 towards the surroundings 2 and thus towards the outside.

The leaf element 1 has an outer skin, also referred to as the overall outer skin 8, which, in the closed position of the leaf element 1 shown in FIG. 1, is optically and haptically perceptible by a person who is present in the surroundings 2. A first part of the overall outer skin 8 is formed by an outer skin, also referred to as a paneling outer skin 9, of the outer skin element 6. A second part of the overall outer skin 8 is formed by an outer skin of the cladding element 7, also referred to as cladding element outer skin 10. For example, the cladding element 7 is formed from a plastic. For example, the cladding element 7 is designed as a cover, or the cladding element 7 is also referred to as a cover. In particular, it can be provided that, by means of the cladding element 7 in the closed position of the leaf element 1, a vehicle pillar of the body, which pillar is in particular designed as a B-pillar, overlaps outwards and thus at least partially towards the surroundings 2 in the vehicle transverse direction of the vehicle and is thus clad, so that the cladding element 7 is also referred to as a B-pillar panel, for example.

It can be seen particularly well from FIG. 1 that the leaf element 1 designed as a vehicle door, and therefore as a door, has a beltline 11 also referred to as a sill or window sill, which is also referred to as a waist line or forms a waist line of the vehicle. Furthermore, the leaf element 1 comprises, for example, a side window, which is also simply referred to as a window and which cannot be seen in FIG. 1 and which is displaceable, i.e., movable, relative to the body shell 5 and relative to the outer paneling element 6, and therefore relative to the base body 4, at least with respect to the closed position of the leaf element 1 in the vehicle vertical direction of the vehicle. In particular, the base body 4 comprises, for example, the body shell 5, the outer paneling element 6 and the cladding element 7. It is contemplated that, for example, a third part of the overall outer skin 8 is formed by an outer skin of the side window, also referred to as a window outer skin. The vehicle vertical direction of the vehicle is illustrated in FIG. 1 by a double arrow 12. In particular, the side window can be moved, i.e., displaced, at least with respect to the closed position of the leaf element 1 in the vehicle vertical direction of the vehicle between a closed position and an open position relative to the body shell 5 and relative to the outer paneling element 6 and also relative to the cladding element 7, in particular in a translatory manner. The open position is also referred to as the window open position, and the closed position is also referred to as the window closed position. In this case, a window region, also referred to as a pane region, is at least partially delimited by the beltline 11, in particular downwards in the vehicle vertical direction of the vehicle in the installation position of the leaf element 1.

In the exemplary embodiment shown in FIG. 1, the pane region (window region) is a window opening, also referred to as pane opening, which can be bounded, for example, by a window frame of the leaf element 1, wherein the window frame can include, for example, the beltline 11. In particular, for example, the window frame is a component of the base body 4. In the closed position, the side window is arranged at least partially in the window region, in particular in such a way that the window opening is at least partially, in particular at least predominantly and thus at least to more than half or even completely, closed by the side window. In particular, it is provided that in the closed position (window closed position) of the side window, the beltline 11 adjoins the side window downward in the vehicle vertical direction of the vehicle in the installed position of the leaf element 1, in particular with respect to the closed position of the leaf element 1.

It can be seen from FIG. 1 that the leaf element 1 has a shaft 13, also referred to as a pane shaft or window shaft, which, in the installed position of the leaf element 1 and thus in the closed position of the leaf element 1, is formed in the vehicle transverse direction outwards and thus towards the surroundings 2, in particular directly, by the body shell 5 and/or the outer paneling element 6. In particular, in the installation position of the leaf element 1 and thus in the closed position of the leaf element 1, the shaft 13 is overlapped outwards in the vehicle transverse direction of the vehicle and thus towards the surroundings 2 by the outer paneling element 6 and/or the body shell 5. The vehicle transverse direction is illustrated in FIG. 1 by a double arrow 14.

In the window open position of the side window, at least one partial region of the side window, also referred to as window partial region, is arranged in the shaft 13 and thus in particular outside the window region, in particular in such a way that the window partial region is arranged below the beltline 11 and also below the window region in the open position in the vehicle vertical direction of the vehicle, in particular with respect to the installation position of the leaf element 1 and thus with respect to the closed position of the leaf element 1. In the closed position (window closed position) of the side window, the window partial region is arranged outside the shaft 13 and in the window region, in particular in such a way that the window partial region is arranged above the beltline 11 in the vehicle vertical direction, in particular, at least with respect to the installation position and thus to the closed position of the leaf element 1. In other words, in the window closed position, the beltline 11 adjoins the partial window region downward in the vehicle vertical direction. For example, in the closed position (window closed position) of the side window, the window region or the window opening is closed at least partially, in particular at least predominantly and thus at least to an extent of more than half or even completely, by the window partial region.

The leaf element 1 has an outer handle 15, which is an outer-side handle element on the door exterior side. The outer handle 15 is also referred to as an outer door handle. The outer handle 15 (handle element) is arranged in the installation position of the leaf element 1 and thus, with respect to the closed position of the leaf element 1, in particular at least partially and very preferably at least predominantly or completely, above the beltline 11 in the vehicle vertical direction of the vehicle. The feature that the outer handle 15 is arranged on the exterior side of the door or on the exterior side, and is therefore an exterior-side handle element or a handle element on the exterior side of the door handle element, is to be understood to mean that the outer handle 15 is arranged on an exterior side AS of the leaf element 1, the exterior side AS of which faces away from the interior 3 and faces the surroundings 2 in the installation position of the leaf element 1 and thus at least in the closed position of the leaf element 1. The person who is present in the surroundings 2 can grasp the outer handle 15 (handle element) using their hand, for example, and at least partially grasp around it, for example, and subsequently exert a force, in particular a tensile force or a compressive force, on the outer handle 15 (handle element), in order to thereby open the initially closed leaf element 1, for example, and thus move it from the closed position into the open position relative to the body.

The outer handle 15 has an outer skin that is optically and haptically perceptible by the person who is present overall in the surroundings 2 of the vehicle and is also referred to as a handle element outer skin 16, by means of which, for example, a fourth part of the overall outer skin 8 is formed, and which is therefore, in particular, a fourth part of the overall outer skin 8.

In order to be able to operate, in particular actuate, the leaf element 1 in a particularly simple manner, in particular ergonomically and comfortably, the outer handle 15 has a first partial region TB1, also referred to as a first body region or first body part, with a first direction of extent, which is also referred to as a first direction and is illustrated in FIG. 1 by an arrow 20. The first portion TB1 extends along the first direction. In the exemplary embodiment shown in FIG. 1, it is provided that the first partial region TB1 protrudes in the first direction (arrow 20) from the base body 4, in particular from the cladding element 7 and/or from the outer paneling element 6. In particular, the first direction extends in the vehicle transverse direction, in particular outwards, and thus away from the interior 3 when the leaf element 1 is in the installed position and thus with respect to the closed position of the leaf element 1. The outer handle 15 (handle element) also has a second partial region TB2, which is also referred to as a second body region or second body part. The second partial region TB2 protrudes from the first partial region TB1 in a second direction of extent illustrated by an arrow 17 in FIG. 1, which is also referred to as the second direction. The second partial region TB2 extends along the second direction of extent. It can be seen from the arrows 20 and 17 that the first direction and the second direction run perpendicular or obliquely to one another, wherein in the present case the second direction points upward in the vehicle vertical direction, in particular in the installation position of the leaf element 1 and thus with respect to the closed position of the leaf element 1. In particular the second partial region TB2 adjoins an end of the partial region TB1 facing away from the base body 4, in particular along the first direction, such that or as a result, in the exemplary embodiment shown in FIG. 1, the outer handle 15, in particular seen overall, is of L-shaped design and thus, in particular seen overall, has an L-shape. The L-shape is formed by the partial regions TB1 and TB2. Thus, the handle element (outer handle 15) is L-shaped in the embodiment shown in FIG. 1. The partial regions TB1 and TB2 are respective legs of the L-shape, wherein the handle element (outer handle 15) is connected via the partial region TB1 to the base body 4, in particular to the body shell 5. The partial region TB2 adjoins the partial region TB1, in particular in the present case in such a way that the partial region TB2 adjoins an end of the first partial region TB1 facing away from the base body 4, in particular along the first direction.

In order to be able to realize a particularly advantageous operation of the leaf element 1, an operating element 18 which is illustrated particularly schematically in FIG. 1 is provided on the handle element (outer handle 15), for example in such a way that the operating element 18 is integrated into the outer handle 15.

In the exemplary embodiment shown in FIG. 1, the operating element 18 is arranged on an inner side S1 of the outer handle 15, in particular of the second partial region TB2, facing the base body 4, in particular the cladding element 7. It can be seen particularly well from FIG. 1 that the partial regions TB1 and TB2 are arranged above the beltline 11 in the installation position of the leaf element 1 and thus, in relation to the closed position of the leaf element 1, in the vehicle vertical direction of the vehicle. The operating element 18 is arranged above the beltline 11 in the installation position of the leaf element 1 and thus, in relation to the closed position of the leaf element 1, in the vehicle vertical direction of the vehicle.

By means of the operating element 18, a lock designed in the present case as a door lock can be electrically unlocked by operating, in particular actuating, the operating element 18. The lock is, for example, a component of the leaf element 1 and thus together with the leaf element 1 movable, in particular pivotable, together relative to the body of the vehicle between the open position and the closed position of the leaf element 1.

By means of the lock, the leaf element 1 can be held in the closed position relative to the body and thus secured in the closed position, so that the leaf element 1 can be secured by means of the lock against a movement from the closed position into the open position occurring relative to the body. For this purpose, the lock will be or is locked in the closed position of the leaf element 1, that is to say is adjusted into a locked state of the lock. By operating the operating element 18, the lock can be electrically unlocked, i.e., electrically brought, i.e., transferred, from the locked state into an unlocked state of the lock. By moving the lock from the locked state into the unlocked state of the lock, the lock releases the leaf element 1 initially located in the closed position for a movement from the closed position into the open position relative to the body of the vehicle.

In order to be able to realize a particularly advantageous, in particular a particularly secure, operation of the leaf element 1, it is additionally provided that the outer handle 15 (handle element) is held on the base body 4, in particular on the body shell 5, movably relative to the base body 4 and thus relative to the body shell 5, relative to the outer paneling element 6, relative to the cladding element 7 and in the present case also relative to the side window from a rest position R shown and designated by R in FIG. 1 into an actuated position, in particular between the rest position R and the actuated position. By moving the outer handle 15 from the rest position R into the actuated position, the lock can be unlocked, in particular purely mechanically, and can therefore be transferred, in particular purely mechanically, from the locked state into the unlocked state. For this purpose, a transmission element 19 is provided, which is illustrated particularly schematically in FIG. 1 and is, for example, flexurally slack. In particular, the transmission element 19 is a flexible traction means. For example, the transmission element 19 can be a cable, in particular a traction cable, so that the transmission element 19 can be a Bowden cable.

When the outer handle 15 is moved from the rest position R into the actuated position, the transmission element 19 is moved together with the outer handle 15, for example. The transmission element 19 is coupled, for example, to the outer handle 15 and to the lock. In other words, by moving the outer handle 15 from the rest position R into the actuated position, the transmission element 19 is moved, wherein by moving the transmission element 19 the lock is unlocked mechanically, in particular purely mechanically. In particular, for example, when the outer handle 15 is moved from the rest position R into the actuated position, a force is transmitted via the transmission element 19 to the lock, whereby the lock is mechanically unlocked, in particular purely. In order to be able to realize a particularly advantageous operation of the leaf element 1, the leaf element 1 has a securing device 21 which has an electrically operable actuator 22.

The actuator 22 is formed separately from the body shell 5 and is held on the body shell 5 for example via a carrier element 23, also referred to simply as a carrier or carrier part, in particular the securing device 21. In this case, for example, the carrier element 23 is formed separately from the body shell 5 and is fastened, in particular fixed, at least indirectly, in particular directly, to the body shell 5. For example, the securing device 21 has a blocking element 24 which is illustrated particularly schematically in FIG. 1 and which can be designed, for example, as a blocking plunger.

As is illustrated in FIG. 1 by a double arrow 25, the blocking element 24 can be moved, in particular translationally, relative to the body shell 5 between a blocking position, also referred to as an arresting position or securing position, and a release position. In particular, for example, the blocking element 24 can be moved by means of the actuator 22 and in this case by the electrical operation of the actuator 22 from the blocking position (arresting position) into the release position relative to the body shell 5, in particular in a translatory manner. The actuator 22 can be electrically operated as a result of detecting an accident-induced application of force to the vehicle, in particular to the leaf element 1, in that the actuator 22 can be supplied or is supplied with electrical energy. In other words, if, for example, the aforementioned accident-related application of force to the vehicle is detected by means of a detection device, the actuator 22 is consequently actuated, in particular electrically, and subsequently electrically operated.

By means of this electrical operation of the actuator 22, the securing device 21 is switched from a blocking state to a release state by means of the actuator 22, for example by the blocking element 24 being moved relative to the body shell 5 from the blocking position causing the blocking state into the release position causing the release state by means of the actuator 22. In the blocking position of the blocking element 24 and thus in the blocking state of the securing device 21, the outer handle 15 is secured in the rest position R by means of the blocking element 24 and thus by means of the securing device 21, in particular form-fittingly, and a movement of the outer handle 15 from the rest position R into the actuated position, in particular form-fittingly, is thus prevented. In the release position of the blocking element 24 and thus in the release state of the securing device 21, the blocking element 24 and thus the securing device 21 release the outer handle 15 for its movement from the rest position R into the actuated position B, which takes place relative to the base body 4.

It can be seen that, by the movement of the blocking element 24 brought about or able to be brought about by means of the actuator 22 from the blocking position into the release position, the securing device 21, in particular actively, can be switched over or is switched over from the blocking state into the release state. It is provided here that during the switchover of the securing device 21 from the blocking state into the release state brought about or able to be brought about by means of the actuator 22, that is to say during the movement of the blocking element 24 from the blocking position into the release position brought about or able to be brought about by means of the actuator 22, a movement of the outer handle 15 from the rest position R into the actuated position brought about by the actuator 22 is omitted and the outer handle 15 thus remains in the rest position R, so that after the switchover of the securing device 21 from the blocking state into the release state the outer handle 15 can be moved relative to the base body 4 as a result and preferably only as a result from the rest position R into the actuated position, that an external force acts on the outer handle 15 and moves the outer handle 15 from the rest position R into the actuated position. This external force can be exerted on the outer handle 15 by the aforementioned person who is present in the surroundings, for example, so that after the securing device 21 has been actively switched from the blocking state to the release state by means of the actuator 22, the person can move the outer handle 15, in particular purely, manually from the rest position R into the actuated position relative to the base body 4 and thereby mechanically unlock the lock, in particular purely mechanically. As a result, the person can open the leaf element 1 and thus come to the aid of persons, for example after an accident of the vehicle, who are in the interior 3. A particularly high level of safety can thus be ensured.

### LIST OF REFERENCE SIGNS

1 leaf element
2 surroundings
3 interior
4 base body
5 body shell
6 outer paneling element
7 cladding element
8 overall outer skin
9 paneling outer skin
10 cladding element outer skin
11 beltline
12 double arrow
13 shaft
14 double arrow
15 outer handle
16 handle element outer skin
17 arrow
18 operating element
19 transmission element
20 arrow
21 securing device
22 actuator
23 carrier element
24 blocking element
25 double arrow
AS exterior side
R rest position
TB1 first partial region
TB2 second partial region

1.-9. (canceled)

10. A leaf element for a vehicle, the leaf element being movably arrangeable on a structure of the vehicle between a closed position and at least one open position, comprising:
an outer handle grippable by a person using their hand and movable relative to a base body of the leaf element from a rest position into at least one actuated position;
a lock, by which the leaf element is to be secured in the closed position, wherein by moving the outer handle from the rest position into the actuated position, the lock is mechanically unlockable;
a securing device comprising an electrically operatable actuator that is electrically operatable as a result of a detection of an application of force to the vehicle due to an accident,
wherein the securing device is switched from a blocking state, which secures the outer handle in the rest position, into a release state, which releases a movement of the outer handle from the rest position into the actuated position, via the actuator by electrically operating the actuator.

11. The leaf element according to claim 10, wherein
during the switching of the securing device from the blocking state to the release state resulting from the electrical operation of the actuator, a movement of the outer handle from the rest position into the actuated position is omitted.

12. The leaf element according to claim 11, further comprising:
an operating element by which the lock is electrically unlocked.

13. The leaf element according to claim 12, wherein the operating element is provided on the outer handle.

14. The leaf element according to claim 10, wherein
the leaf element is a door with a beltline, and
the outer handle is arranged above the beltline.

15. The leaf element according to claim 14, further comprising:
an operating element by which the lock is electrically unlocked,
wherein the operating element is arranged above the beltline.

16. The leaf element according to claim 10, wherein,
in the blocking state, the securing device secures the outer handle form-fittingly in the rest position.

17. The leaf element according to claim 10, wherein
the securing device has a lever arrangement which, in the blocking state, assumes an over-dead-center position, by which the outer handle is held in the rest position, and
by electrically operating the actuator, the lever arrangement is moved out of the over-dead-center position and is moved beyond a dead center of the lever arrangement, as a result of which the securing device is switched over from the blocking state into the release state and the movement of the outer handle is released from the rest position into the actuated position.

18. A vehicle comprising at least one leaf element according to claim 10.
